(19) United States
(12) Patent Application Publication
(10) Pub. No.: US 2015/0078419 A1
(43) Pub. Date: Mar. 19, 2015

(54) UWB PULSE SHAPING FILTERS WITH REDUCED COMPLEXITY AND HIGH SPECTRAL EFFICIENCY

(71) Applicant: QUALCOMM Incorporated, San Diego, CA (US)

(72) Inventors: Alok Kumar Gupta, San Diego, CA (US); Siavash Ekbatani, San Diego, CA (US)

(73) Assignee: QUALCOMM Incorporated, San Diego, CA (US)

(21) Appl. No.: 14/201,156

(22) Filed: Mar. 7, 2014

Related U.S. Application Data
(60) Provisional application No. 61/879,663, filed on Sep. 18, 2013.

(51) Int. Cl. H04B 1/7163; H04B 1/717

(52) U.S. Cl. CPC H04B 1/7163; H04B 1/7172
USPC 375/130

(57) ABSTRACT

Methods, systems, and devices are described for maximizing transmit power of an ultra-wideband (UWB) pulse. A spectral mask and a spectral efficiency may be identified. A set of transmit filter coefficients may be generated at a fraction of a carrier frequency. The set of transmit filter coefficients may be based at least in part on the identified spectral mask and spectral efficiency. The UWB pulse may be transmitted with a shape defined at least in part by the set of transmit filter coefficients.

### CROSS REFERENCES

The present application claims priority to U.S. Provisional Patent Application No. 61/879,663 by Gupta et al., entitled “UWB Pulse Shaping Filters with Reduced Complexity and High Spectral Efficiency,” filed Sep. 18, 2013, and assigned to the assignee hereof.

### BACKGROUND

In some settings, such as in indoor and enterprise environments, it may be important to easily locate various types of assets or people, or both. Examples of such settings include hospitals, retail stores, warehouses, etc. The accuracy and speed with which the location of assets or people is monitored in an indoor setting may be an important factor in determining the usefulness of the tracking system. In addition, having a tracking system that is cost effective, scalable, and that can provide continuous, accurate, and precise location monitoring is also desirable.

Different systems and devices may be used to locate assets and/or people in a particular indoor environment. An ultra-wideband (UWB) network, or some other radio frequency network deployed throughout at least a portion of the indoor environment, may be configured to perform indoor tracking. Systems may employ multiple access points (APs) placed at specific locations in the indoor environment. A location tracking tag also may be attached to each mobile asset and/or to each person to be tracked. The tag may send waveforms (e.g., beacon signals) that are received by the APs for ranging measurements to determine the distance between the tag and the APs that receive the waveforms. Once the distances between the tag and at least three different APs are obtained, triangulation or trilateration (or multilateration) may be used to determine the location of the tag.

In some cases, design or regulatory constraints, or both, may limit the power with which signals may be transmitted. It may therefore be desirable to transmit a signal or pulse at a maximum allowable power while operating within design and regulatory constraints and with minimum implementation complexity.

### SUMMARY

Methods, systems, and devices are described for maximizing transmit power of an ultra-wideband (UWB) pulse. A spectral mask and a spectral efficiency may be identified. A set of transmit filter coefficients may be generated at a fraction of a carrier frequency. The set of transmit filter coefficients may be based at least in part on the identified spectral mask and spectral efficiency. The UWB pulse may be transmitted with a shape defined at least in part by the set of transmit filter coefficients.

In one embodiment, a maximum transmit filter coefficient may be identified based at least in part on the identified spectral mask and spectral efficiency. The set of transmit filter coefficients may include the maximum transmit filter coefficient. In one configuration, a sampling rate of the UWB pulse may be identified. The identified sampling rate may be based at least in part on the carrier frequency. In one example, a number of transmit filter taps may be determined based at least in part on the maximum transmit filter coefficient and the sampling rate.

In one configuration, the fraction of the carrier frequency is one-half of the carrier frequency. The set of transmit filter coefficients may be unquantized filter coefficients. In one embodiment, the set of transmit filter coefficients may be uniformly quantized filter coefficients. In one example, the set of transmit filter coefficients may be non-uniformly quantized filter coefficients.

In one embodiment, the set of transmit filter coefficients may be implemented in passband by modulating a radio frequency (RF) carrier at the carrier frequency. In one example, a radio frequency (RF) carrier may be modulated with each gain provided by the set of transmit filter coefficients. The RF carrier may be modulated with each gain for a period of two RF cycles. In one configuration, the spectral mask may include a universal spectral mask.

An apparatus for maximizing transmit power of an ultra-wideband (UWB) pulse is also described. The apparatus may include means for identifying a spectral mask and a spectral efficiency. The apparatus may further include means for generating a set of transmit filter coefficients at a fraction of a carrier frequency. The set of transmit filter coefficients may be based at least in part on the identified spectral mask and spectral efficiency. The apparatus may further include means for transmitting the UWB pulse with a shape defined at least in part by the set of transmit filter coefficients.

An apparatus for maximizing transmit power of an ultra-wideband (UWB) pulse is also described. The apparatus may include a processor and a memory in electronic communication with the processor. The apparatus may further include instructions stored in the memory. The instructions may be executable by the processor to identify a spectral mask and a spectral efficiency. The instructions may also be executable by the processor to generate a set of transmit filter coefficients at a fraction of a carrier frequency. The set of transmit filter coefficients may be based at least in part on the identified spectral mask and spectral efficiency. The instructions may be further executable by the processor to transmit the UWB pulse with a shape defined at least in part by the set of transmit filter coefficients.

A computer program product for maximizing transmit power of an ultra-wideband (UWB) pulse is also described. The computer program product may include a non-transitory computer readable medium. The computer readable medium may store instructions thereon. The instructions may be executable by a processor to identify a spectral mask and a spectral efficiency. The instructions may also be executable by the processor to generate a set of transmit filter coefficients at a fraction of a carrier frequency. The set of transmit filter coefficients may be based at least in part on the identified spectral mask and spectral efficiency. The instructions may be further executable by the processor to transmit the UWB pulse with a shape defined at least in part by the set of transmit filter coefficients.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIGS. 1A and 1B show an example(s) of a location tracking system in accordance with various embodiments;

FIGS. 2A and 2B, show block diagrams of example device(s) that may be employed in location tracking systems in accordance with various embodiments;

FIGS. 2B-1, 2B-2, 2B-3, and 2B-4 show graphs of shaped pulses generated in accordance with various embodiments;

FIG. 2C shows a block diagram of an example device(s) that may be employed in location tracking systems in accordance with various embodiments;

FIG. 3 shows a block diagram of an example of a location tracking system in accordance with various embodiments;

FIG. 4 shows a block diagram of an example of a location tracking system in accordance with various embodiments;

FIG. 5 shows a block diagram of an example of a location tracking system in accordance with various embodiments;

FIG. 6 is a flow diagram of a method of communication with a location tracking system in accordance with various embodiments; and

FIG. 7 is a flow diagram of a method of communication with a location tracking system in accordance with various embodiments.

### DETAILED DESCRIPTION

Methods, systems, and devices that provide for effectively maximizing transmit UWB pulse transmissions are described. These may include techniques for pulse shaping at a UWB transmitter. Determining and implementing a pulse shaping UWB transmitter, may help achieve a goal of maximizing transmit power while meeting various spectral mask requirements. Moreover, pulse shaping may facilitate low cost, low-power hardware (e.g., radio frequency (RF) circuit) implementation.

Pulse shaping filters may be employed to achieve desirable spectral efficiency while operating within a universal UWB spectral mask. For example, a set of quantized pulse shaping filters may be employed. In other cases, un-quantized pulse shaping filters are utilized to achieve similar results.

The following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

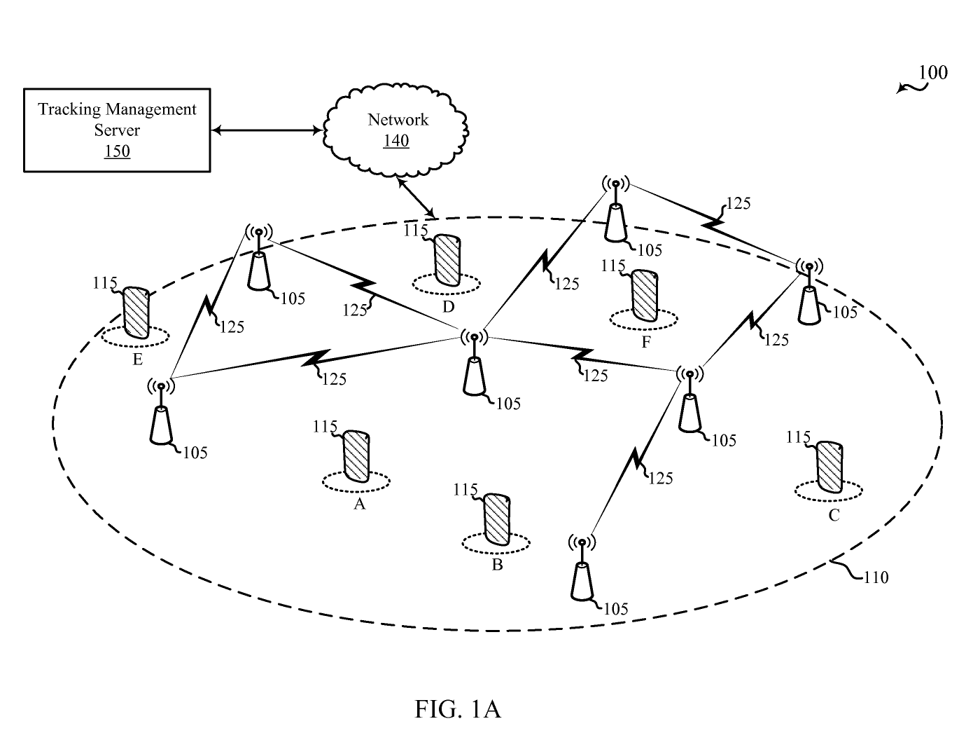

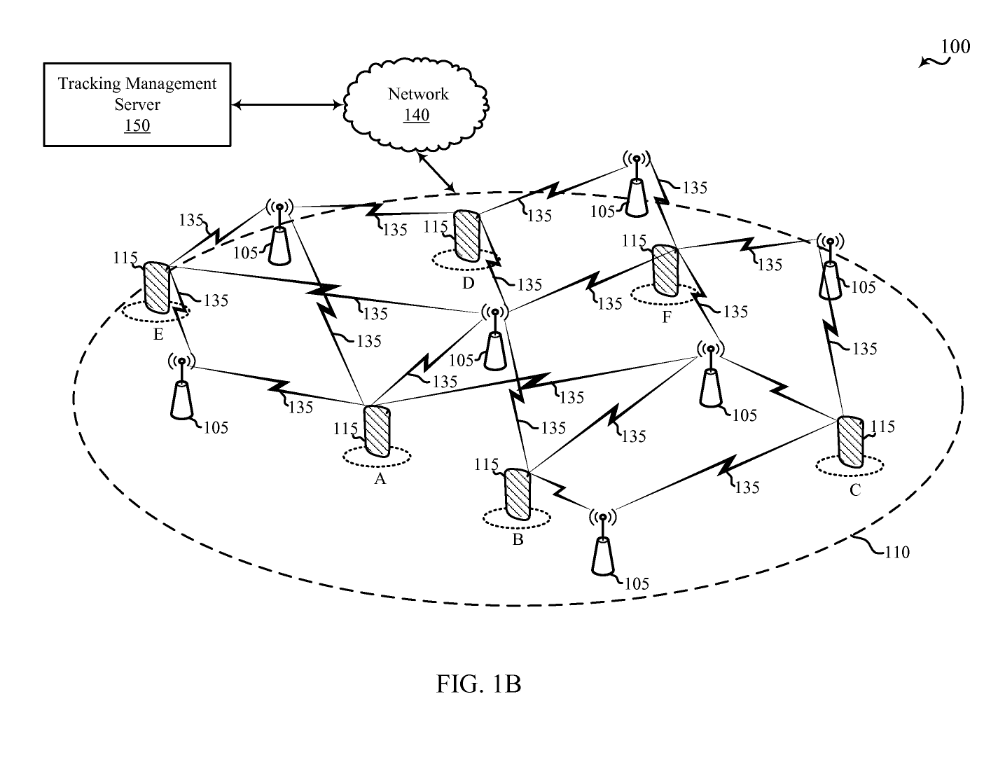

First, FIG. 1A depicts an example of a location tracking system 100 in accordance with various embodiments. The system 100 provides location tracking of assets (e.g., objects) or people, or both, throughout the coverage area 110 associated with an indoor and/or enterprise environment. In some embodiments, the coverage area 110 represents an area of coverage inside a building, such as a hospital, a retail store, or a warehouse. Within the coverage area 110, multiple APs 105 may be deployed at specific locations, as may multiple tags 115 (also referred to as tag units and location tracking tags), which may be tracked within the coverage area 110. Because of their stationary nature, the exact distance between any two APs 105 is typically known, or may be determined, throughout the operation of the system 100. Any two APs 105 may ascertain the distance between themselves through a ranging operation, which may be a two-way ranging operation. The ranging operation may be performed via communication links 125.

The arrangement of APs 105 shown in FIG. 1A is intended as a non-limiting example. The APs 105 may be deployed or distributed within the coverage area 110 in a manner or pattern different from that depicted in FIG. 1A. For example, the APs 105 may be arranged at different distances from one another. In some cases, the coverage area 110 represents a two-dimensional deployment, such as a single floor within a building. But in some embodiments, the APs 105 are deployed in a three-dimensional manner by placing some of the APs 105 on different floors or levels of a building within the coverage area 110.

Each of the APs 105 may be equipped with a narrowband transceiver or a UWB transceiver, or both. Additionally or alternatively, the APs 105 may include one or more oscillators or timers, or both. The oscillators may each produce a repetitive, oscillating electronic signal, which may be adjustable and/or variable. The oscillators may be radio frequency (RF) oscillators. The oscillators may be linear- or relaxation-type. In some embodiments, the oscillators are voltage controlled, temperature compensated crystal oscillators (VCTCXO). The timers may include quartz clock(s), they may be digital, and/or they may be implemented in software.

Each of the tag units 115 may be attached to an asset or a person being tracked within the coverage area 110. The tag units 115 may be equipped with a narrowband transceiver or a UWB transmitter, or both. The tag units 115 may also have one or more oscillators or timers, or both. The oscillators may each produce a repetitive, oscillating electronic signal, which may be adjustable and/or variable. The oscillators may be RF oscillators. The oscillators may be linear- or relaxation-type. By way of example, the oscillators are VCTCXO. The timers may include quartz clock(s), they may be digital, and/or they may be implemented in software. Those skilled in the art will recognize that the tools and techniques described herein may be implemented with oscillators of varying frequency, and timers of varying clock speeds.

FIG. 1A depicts an example location tracking system 100 with six tag units 115 at locations A, B, C, D, E, and F. Over time, these locations may change as the assets or people to which the tags 115 are attached move or are moved within the coverage area 110. The system 100, shown with six tags 115, is intended as a non-limiting example of a location tracking system. Those skilled in the art will recognize that the system 100 is scalable, and it may be capable of tracking more or fewer assets or people.

The system 100 includes a tracking management server 150, which also may be referred to as a tag tracking management server or a location tracking server. In some embodiments, the tracking management server 150 is connected to the APs 105 through a network 140. The connection may be by way of a radio network associated with the APs 105. The tracking management server 150 may receive information from the APs 105 to perform various types of calculations, including: identifying a spectral mask and/or a spectral efficiency; generating one or more sets of transmit filters for the APs 105; identifying a sampling rate of a UWB pulse; and/or determining a number of transmit filter taps.

The APs 105 may communicate with one another by sending and/or receiving UWB signals. The channels between APs 105, which are associated with communication links 125, are often characterized by noise and signal-degrading impedances. It may therefore be beneficial to maximize UWB signal transmit power, which may be achieved by utilizing a pulse shaping filter.

Selecting and implementing a pulse shaping filter may involve generating a set of transmit filter coefficients based on an identified spectral mask (e.g., a universal spectral mask), and/or a minimum desired spectral efficiency. According to some embodiments, transmit filter coefficients are generated based on a fraction of a carrier frequency (e.g., the carrier or central frequency of a UWB signal). This fraction of a carrier frequency may be one-half of the carrier frequency, for example. In some cases, the set of transmit filter coefficients includes a maximum transmit filter coefficient. For example, a maximum transmit filter coefficient may be identified, and it may be relied upon to determine a number of transmit filter taps to employ. In some cases, transmit filter taps are also a function of an identified sampling rate of a UWB pulse. UWB pulses may be implemented with a finite transition time (e.g., a linear or exponential transition time) within certain tolerances and within the identified spectral mask.

FIG. 1B illustrates transmissions or broadcasts between APs 105 and tags 115 via communication links 135. The tags 115 may communicate with APs 105 by sending and/or receiving UWB signals. The channels between APs 105 and the tags 115, which are associated with communication links 135, are often characterized by noise and signal-degrading impedances. So, as with transmission between APs 105, it may be beneficial to maximize UWB signal transmit power for communications between tags 115 and APs 105. For example, a tag 115 may transmit a UWB signal, which has a pulse shaped according to transmit filter coefficients generated at a fraction of a carrier frequency and based on an identified spectral mask and spectral efficiency. In other words, the tags 115 may transmit UWB pulses shaped to maximize transmit power and spectral efficiency while operating within a designated spectral mask.

A controller within a tag 115 may identify a spectral mask and a preferred spectral efficiency. Based on these, the tag 115 may generate a set of transmit filter coefficients at a fraction of a carrier frequency. The tag 115 may then transmit a UWB pulse with a shape that is defined by the set of transmit filter coefficients. In some cases, the shape of the pulse is such that the signal maximizes transmit power and spectral efficiency without violating the identified spectral mask. In further embodiments, the tag 115 may implement the set of transmit filter coefficients in passband by modulating an RF carrier at the carrier frequency. Additionally or alternatively, the tag 115 may modulate an RF carrier with each gain provided by the set of transmit filter coefficients—e.g., the RF carrier may be modulated with each gain for a period of two RF cycles.

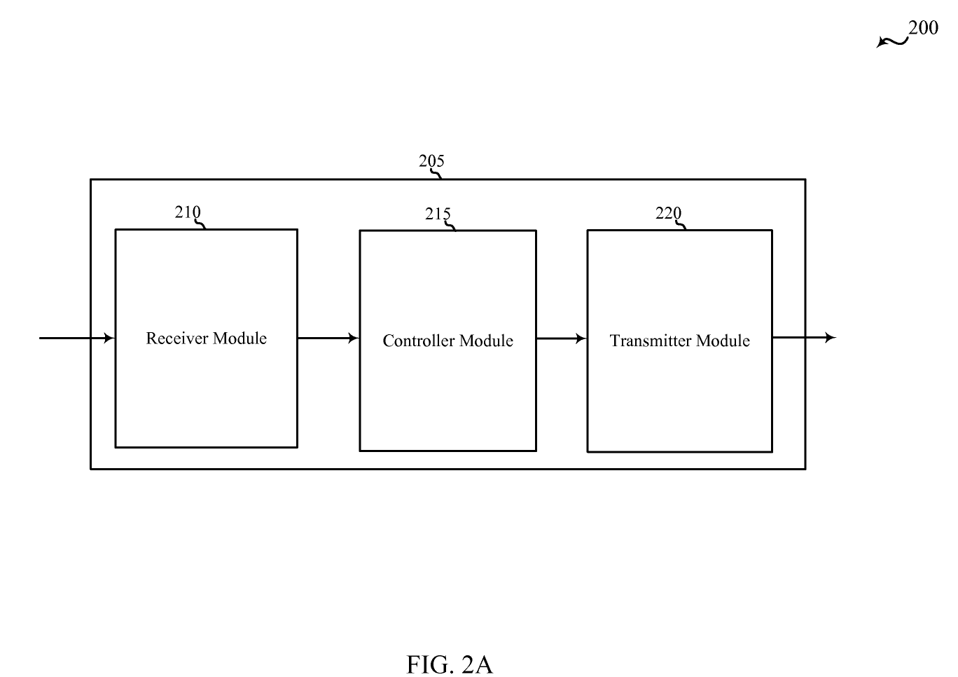

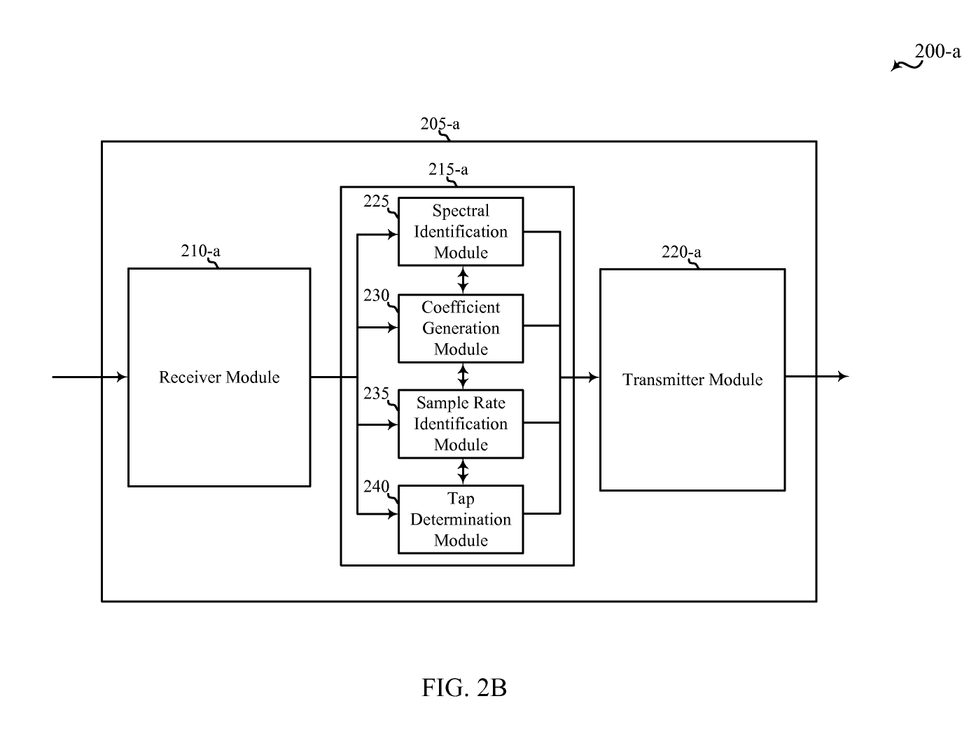

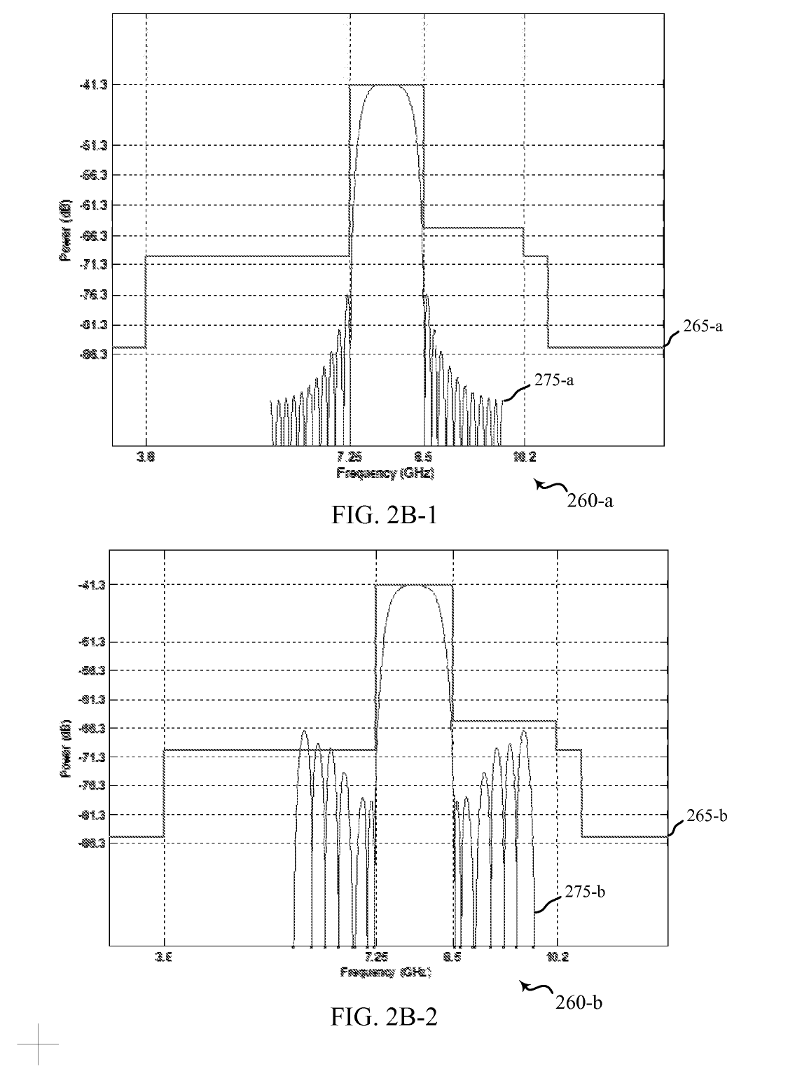

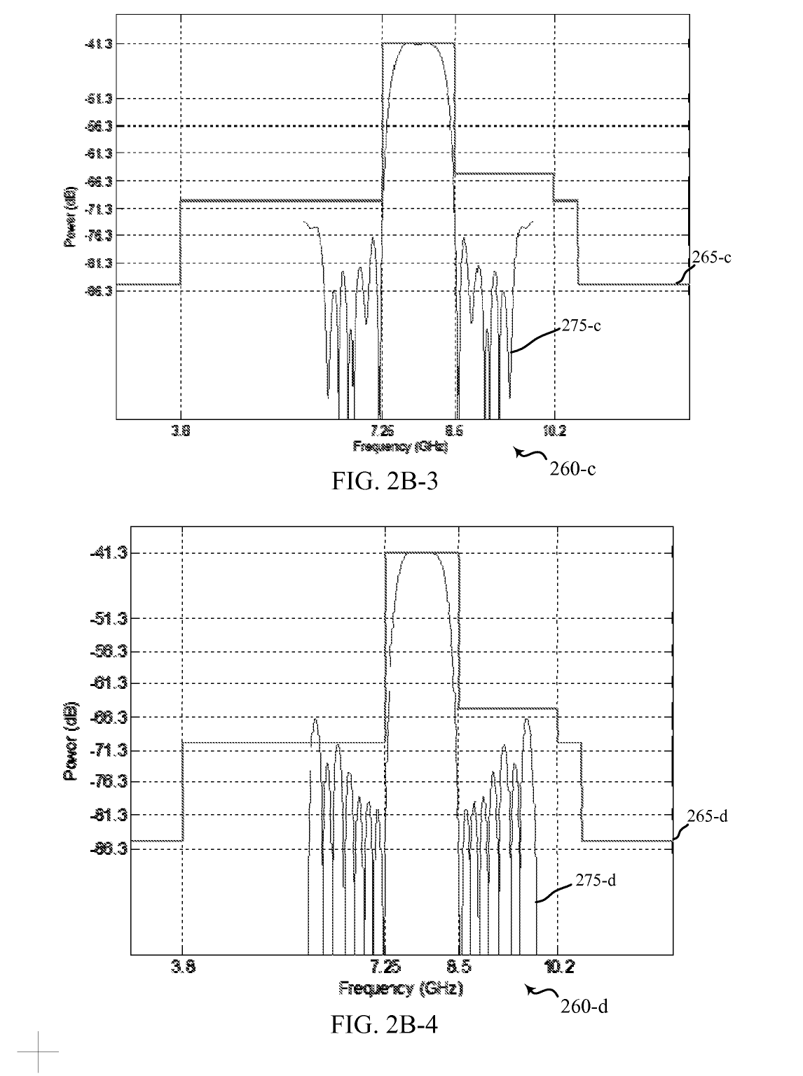

Next, turning to FIG. 2A, a block diagram 200 of a device 205 is shown. The device 205 is configured for communication within a location tracking system in accordance with various embodiments. The device 205 may be an aspect of an AP 105 and/or a tag 115 described with reference to FIG. 1A or FIG. 1B, or both. The device 205 may also be a processor. The device 205 may include a receiver module 210, a controller module 215, and/or a transmitter module 220. The receiver module 210 may be configured to receive UWB signals, including pulse shaped signals, which may allow for maximum transmit power without violating a spectral mask.

The controller module 215 may process or control processing of signals received by the receiver module 210. Additionally or alternatively, the controller module 215 may process and prepare signals for transmission via the transmitter module 220. In some cases, the controller module 215 is designed to maximize transmit power, including by determining a pulse shaping filter for the transmitter module 220.

The transmitter module 220 may be a UWB transmitter, which may include a filter having coefficients generated at a fraction of a carrier frequency and based on an identified spectral mask and/or spectral efficiency.

The receiver module 210, the controller module 215, and/or the transmitter module 220 may be implemented in a single device. In some embodiments, the components of the device 205 are, individually or collectively, implemented with one or more application-specific integrated circuits (ASICs) adapted to perform some or all of the applicable functions in hardware. Alternatively, the functions may be performed by one or more processing units (or cores), on one or more integrated circuits. In other embodiments, other types of integrated circuits are used (e.g., Structured/Platform ASICs, field-programmable gate arrays (FPGAs), and other Semi-Custom integrated circuits (ICs)), which may be programmed in any manner known in the art. The functions of each unit also may be wholly or partially implemented with instructions embodied in a memory, formatted to be executed by one or more general or application-specific processors.

FIG. 2B shows a block diagram 200-a of a device 205-a configured for communication in a location tracking system in accordance with various embodiments. The device 205-a may be an example of the device 205 of FIG. 2A; it may also perform substantially the same functions as described with reference to FIG. 2A. The device 205-a may be an example an AP 105 and/or a tag 115, which, in some embodiments, includes aspects of the APs 105 and tags 115 described above with reference to FIGS. 1A, 1B, and 2A. In some embodiments, the device 205-a is a processor. The device 205-a may include one or more of a receiver module 210-a, a controller module 215-a, and a transmitter module 220-a. For example, these modules may be configured to perform substantially the same functions as the corresponding modules of device 205 of FIG. 2A.

The controller module 215-a may be equipped with submodules configured to maximize transmit power of a UWB pulse. For example, the controller module 215-a may determine and/or select a pulse shaping filter of a transmitter or transceiver of an AP 105 and/or a tag 115. The controller module 215-a may include a spectral identification module 225, a coefficient generation module 230, a sample rate identification module 235, and/or a tap determination module 240. In some cases, the spectral identification module 220 is configured to identify a spectral mask and/or a spectral efficiency. The spectral identification module 220 may identify either or both the spectral mask and spectral efficiency based upon information transmitted from the tracking management server 150. The coefficient generation module 230 may be configured to generate a set of transmit filter coefficients at a fraction of a carrier frequency, based on the identified spectral mask and/or spectral efficiency. In some cases, the coefficient generation module 230 is also configured to identify a maximum transmit filter coefficient based on the spectral mask and spectral efficiency. The sample rate identification module 235 may be configured to identify a sampling rate of a UWB pulse based on the carrier frequency. Then, in some embodiments, the tap determination module 240 is configured to determine a number of transmit filter taps based on the maximum transmit filter and the sampling rate.

In some embodiments, the generated set of transmit filter coefficients is based on one-half of the carrier frequency. Additionally or alternatively, the transmit filter coefficients may be unquantized filter coefficients. In other cases, the transmit filter coefficients are uniformly quantized filter coefficients. In still other embodiments, the transmit filter coefficients are non-uniformly quantized coefficients.

By way of example, a carrier frequency may be 7.875 GHz. Based on a spectral mask and a minimum spectral efficiency, a maximum filter coefficient of fourteen (14) may be identified. In some embodiments, such as those employing unquantized filters and thirty one (31) taps, a generated set of transmit filter coefficients may be as follows: {0.0373, −0.1651, −0.2395, −0.0664, 0.2810, 0.5228, 0.3291, −0.4181, −1.4215, −1.9855, −1.3069, 1.0787, 4.9343, 9.2728, 12.6986, 14.0000, 12.6986, 9.2728, 4.9343, 1.0787, −1.3069, −1.9855, −1.4215, −0.4181, 0.3291, 0.5228, 0.2810, −0.0664, −0.2395, −0.1651, 0.0373}. This example may have a pulse shape as illustrated in FIG. 2B-1 in Graph 260-a.

In Graph 260-a, the line 265-a represents the spectral mask and the cyclic waveform 275-a represents a shaped pulse. Additionally, in the example represented by Graph 260-a, the pass band loss equals 2.09 dB.

In other embodiments, such as those employing uniformly quantized filters and twenty one (21) taps, a generated set of transmit filter coefficients may be as follows: {1, 0, 0, −1, −2, −1, 1, 5, 9, 13, 14, 13, 9, 5, 1, −1, −2, −1, 0, 0, 1}. This example has a maximum identified transmit filter coefficient of fourteen (14), and a pulse shape as illustrated in FIG. 2B-2 in Graph 260-b.

In Graph 260-b, the line 265-b represents the spectral mask and the cyclic waveform 275-b represents a shaped pulse. Additionally, in the example represented by Graph 260-b, the pass band loss equals 2.33 dB.

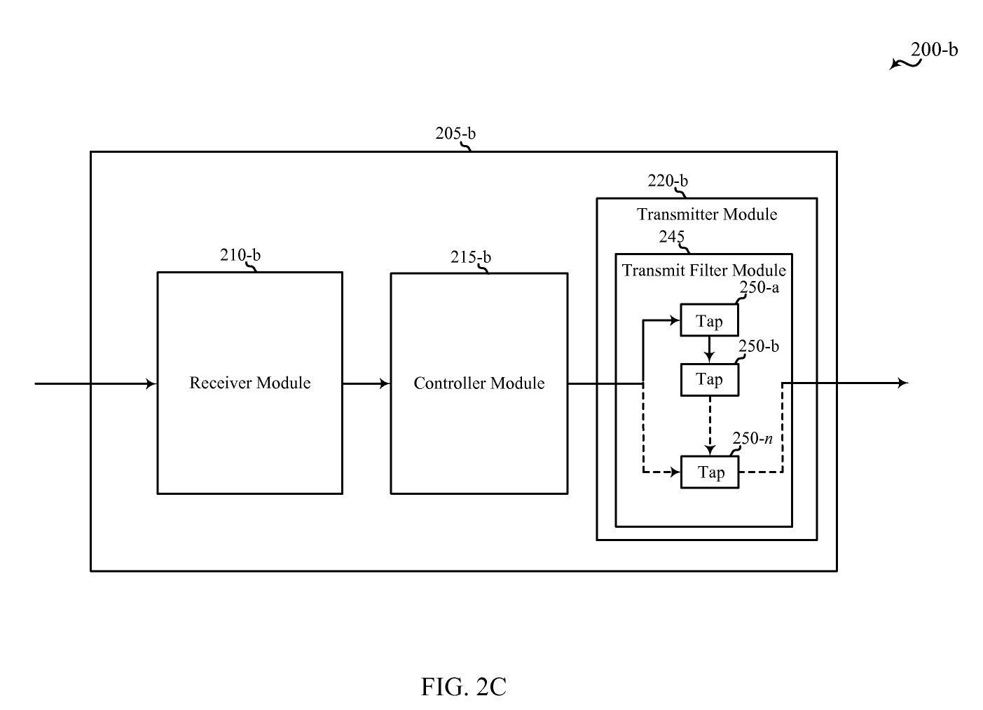

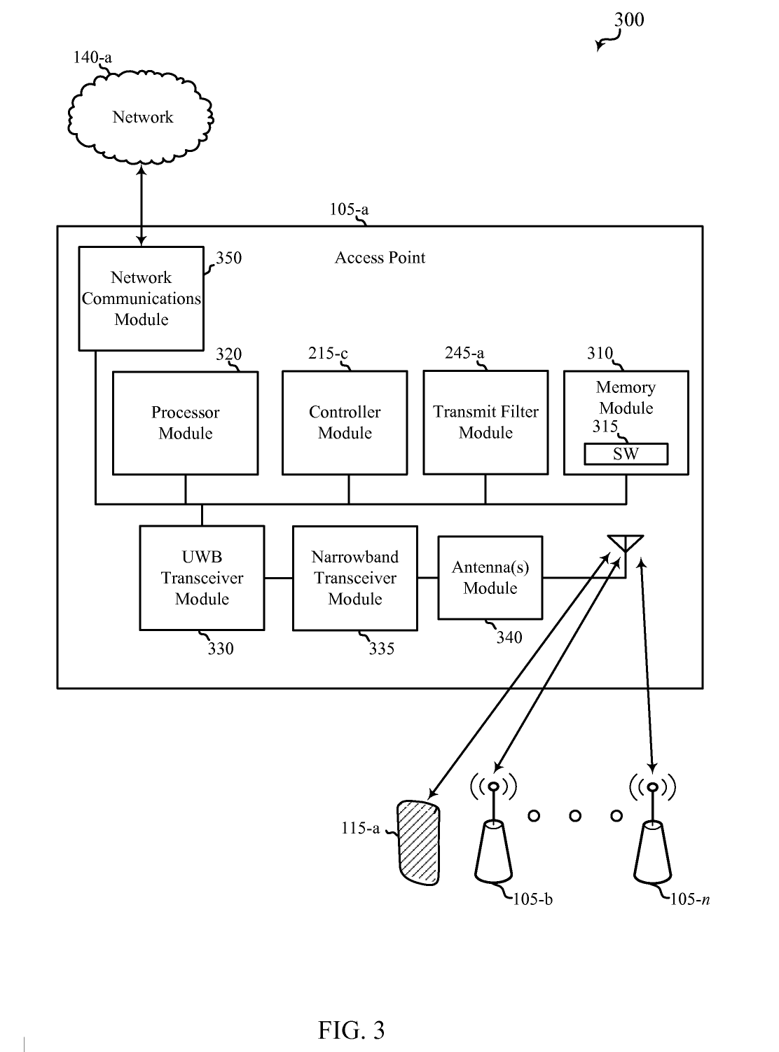

In other cases, such as those employing non-uniformly quantized filters and twenty one (29) taps, a generated set of transmit filter coefficients may be as follows: {−0.25, −0.25, 0, 0.25, 0.50, 0.25, −0.50, −1.5, −2, −1.25, 1, 5, 9, 13, 14, 13, 9, 5, 1, −1.25, −2, −1.5, −0.50, 0.25, 0.50, 0.25, 0, −0.25, −0.25}. This example also has a maximum identified transmit filter coefficient of fourteen (14), and a pulse shape as illustrated in FIG. 2B-3 in Graph 260-c.

In Graph 260-c, the line 265-c represents the spectral mask and the cyclic waveform 275-c represents a shaped pulse. Additionally, in the example represented by Graph 260-c, the pass band loss equals 2.12 dB.

In still other embodiments, including those employing uniformly quantized filters and twenty three (23) taps, a generated set of transmit filter coefficients may be as follows: {1, 0, 0, −1, −2, −2, −1, 2, 6, 11, 14, 16, 14, 11, 6, 2, −1, −2, −2, −1, 0, 0, 1}. This example may have a pulse shape as illustrated in FIG. 2B-4 in Graph 260-d.

In Graph 260-d, the line 265-d represents the spectral mask and the cyclic waveform 275-d represents a shaped pulse. In the example represented by Graph 260-d, the pass band loss equals 2.22 dB.

The controller module 215-a may control or adjust the transmitter module 220-a of the device 205-a to implement a pulse shaping filter based upon generated coefficients and a determined number of taps. The controller module 215-a may implement the set of transmit filter coefficients in passband by modulating an RF carrier at the carrier frequency. In some embodiments, the controller module 215-a modulates an RF carrier with each gain provided by the set of transmit filter coefficients. For example, the controller module 215-a may implement a pulse shaping filter in the transmitter module 220-a, which may create a shaped pulse as illustrated in one or more of the graphs above.

According to some embodiments, the components of the device 205-a are, individually or collectively, implemented with one or more ASICs adapted to perform some or all of the applicable functions in hardware. In other embodiments, the functions of device 205-a are performed by one or more processing units (or cores), on one or more integrated circuits. In other embodiments, other types of integrated circuits are used (e.g., Structured/Platform ASICs, FPGAs, and other Semi-Custom ICs), which may be programmed in any manner known in the art. The functions of each unit may also be implemented, in whole or in part, with instructions embodied in a memory, formatted to be executed by one or more general or application-specific processors.

Next, FIG. 2C shows a block diagram 200-b of a device 205-b configured for communication in a location tracking system in accordance with various embodiments. The device 205-b may be an example of the devices 205 and/or 205-a of FIGS. 2A and 2B; and the device 205-b may perform the same or similar functions as described above for devices 205 and/or 205-a. In some embodiments, the device 205-b is an example of an AP 105; in other cases it is an example of a tag 115, in any event, it may be an example of one or more aspects of the APs 105 and tags 115 described above with reference to any or all of FIGS. 1A, 1B, 2A, and 2B. In some instances, the device 205-b is a processor. The device 205-b may include one or more of a receiver module 210-b, a controller module 215-b, and a transmitter module 220-b. These modules may perform the same or similar functions as the corresponding modules of device 205 and/or 205-a in FIGS. 2A and 2B.

The device 205-b may also include a transmit filter module 245, which may include one or more transmit filter taps 250-a, 250-b, . . . , 250-n. The number of transmit filter taps 250 may be determined based on an identified maximum transmit filter coefficient and a sampling rate of a UWB pulse, both of which may be based on a spectral mask and a spectral efficiency. A determined number of transmit filter taps 250 may be implemented to shape a UWB pulse, e.g., as is illustrated in Graphs 1-4 above, which may allow for maximum transmit power without violating a spectral mask. The transmit filter module 245 may be controlled, adjusted, and/or determined by the controller module 215-b.

According to some embodiments, the components of the device 205-b are, individually or collectively, implemented with one or more ASICs adapted to perform some or all of the applicable functions in hardware. In other embodiments, the functions of device 205-b are performed by one or more processing units (or cores), on one or more integrated circuits. In other embodiments, other types of integrated circuits are used (e.g., Structured/Platform ASICs, FPGAs, and other Semi-Custom ICs), which may be programmed in any manner known in the art. The functions of each unit may also be implemented, in whole or in part, with instructions embodied in a memory, formatted to be executed by one or more general or application-specific processors.

Turning now to FIG. 3, which depicts a block diagram of a system 300 configured for communication within a location tracking system in accordance with various embodiments. The system 300 may include APs 105-a, and 105-b through 105-n, which may be examples of the APs 105 described with reference to one or more of FIGS. 1A, 1B, 2A, 2B, and 2C. The AP 105-a may include a memory module 310, which, in some embodiments, includes a software module 315. The AP 105-a may include a processor module 320, a UWB transceiver module 330, a narrowband transceiver module 335, antenna(s) module 340, and/or a network communications module 350. Each of the components of the AP 105-a may be in communication with each other. The network communications module 350 may be in communication with the network 140-a, which may be an example of the network 140 of FIGS. 1A and 1B.

In some cases, the AP 105-a includes a controller module 215-c and an transmit filter module 245-a, both of which may be configured to perform substantially the same functions as the corresponding modules of FIGS. 2A-2C. For example, the controller module 215-c may be configured to maximize transmit power by generating transmit filter coefficients based on an identified spectral mask and/or spectral efficiency. The controller module 215-b may also adjust the number of transmit filter taps to obtain a pulse shaping filter, which may be implemented with the transmit filter module 245-a.

The memory module 310 may include random access memory (RAM) and/or read-only memory (ROM). In some embodiments, the memory module 310 also stores computer-readable, computer executable software (SW) code 315 containing instructions configured to, when executed, cause the processor module 320 to perform various functions related to generating transmit filter coefficients, as described herein. In other embodiments, the software (SW) code 315 may not be directly executable by the processor and scheduler module 320; but it may be configured to cause a computer, for example, when compiled and executed, to perform the functions described herein.

The processor module 320 may include an intelligent hardware device, such as a central processing unit (CPU). The processor module 320 may perform various operations associated with determining transmit or receive filter characteristics, or both transmit and receive filter characteristics. The processor module 320 may use information received from, for example, the tracking management server 150, by way of the network 140-a, to generate transmit filter coefficients and/or determine which transmit filter taps to apply.

Either or both of the UWB transceiver module 330 and narrowband transceiver 335 may include a modem configured to modulate data (e.g., packets) and provide the modulated data to the antenna(s) module 340 for transmission, and to demodulate data received from the antenna(s) module 340. The UWB transceiver module 330 may be an example of, or include aspects of, the devices 205, of FIGS. 2A-2C. In some embodiments, the UWB transceiver module 330 includes a transmit filter module that is the same as, or similar to, the transmit filter module 245. Thus, in some cases, the UWB transceiver module 330 includes transmit filter taps like the taps 250. These taps may be adjusted for pulse shaping.

Some embodiments of the AP 105-a include a single antenna; other embodiments include multiple antennas. Signals transmitted from a tag 115-a may be received by the AP 105-a via the antenna(s) in the antenna(s) module 340. The AP 105-a may also wirelessly communicate with other APs, such as APs 105-b through 105-n. The narrowband transceiver module 335 may be a ZigBee radio. In some cases, the AP 105-a may transmit received signals to the tracking management server 150 (shown in FIGS. 1A and 1B) via the network communications module 350 and the network 140-a. For example, the AP 105-a may receive signals from the tracking management server 150 indicative of a spectral mask, preferred spectral efficiency, maximum transmit filter coefficients, carrier frequency, and/or sampling rate.

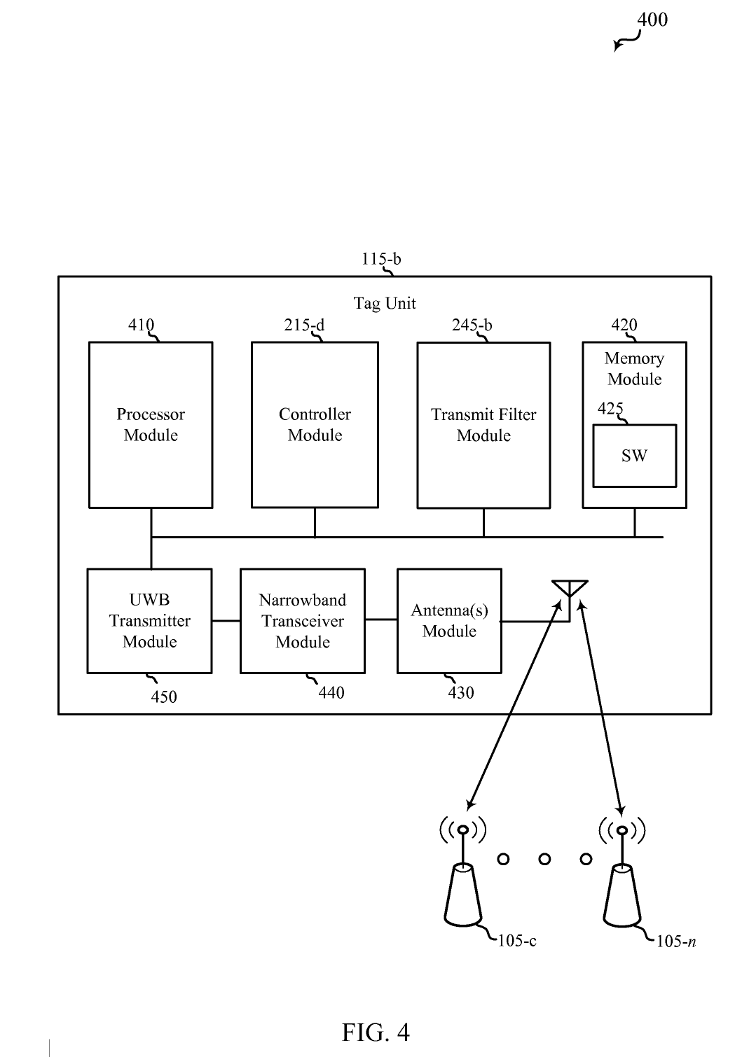

Next, FIG. 4 shows a block diagram illustrating a system 400 configured for communication within a location tracking system according to various embodiments. The system 400 may include a tag unit 115-b. In some embodiments, the tag unit 115-b includes one or more aspects of the tag units 115 of one or both of FIGS. 1A and 1B. The tag unit 115-b may include a processor module 410, a memory module 420, which may include a software (SW) module 425, an antenna(s) module 430, a narrowband transceiver module 440, and/or a UWB transmitter module 450. The UWB transmitter module 450 may include aspects that are the same as, or similar to, the transmitter module 220 of FIGS. 2A, 2B, and 2C. Each of the components of the tag unit 115-b may be in communication with each other.

In some cases, the tag unit 115-b includes a controller module 215-d and an transmit filter module 245-b, both of which may be configured to perform substantially the same functions as the corresponding modules of FIGS. 2A-2C. For example, the controller module 215-d may be configured to maximize transmit power by generating transmit filter coefficients based on an identified spectral mask and/or spectral efficiency. The controller module 215-d may also adjust the number of transmit filter taps to obtain a pulse shaping filter, which may be implemented with the transmit filter module 245-b.

By way of example, the processor module 410 includes logic or code, or both, that enables it to control the operations of the tag unit 115-b. In some cases, the processor module 410 includes a microcontroller or a state machine to control the narrowband transceiver module 440 and the UWB transmitter module 450.

The memory module 420 may include random access memory (RAM) or read-only memory (ROM), or both. In some embodiments, the memory module 420 stores computer-readable, computer-executable software (SW) code 425 containing instructions that are configured to, when executed, cause the processor module 410 to perform various functions described herein for controlling the tag unit 115-b. In other embodiments, the software code 425 is not directly executable by the processor module 410, but it may be configured to cause a computer, for example, when compiled and executed, to perform functions described herein.

The UWB transmitter module 450 may support RF communication technology to broadcast UWB signals through the antenna(s) module 430. Likewise, the narrowband transceiver module 440 may support RF communication technology to broadcast narrowband signals through the antenna(s) module 430. The UWB transmitter module 450 or the narrowband transceiver module 440, or both, may include a modulator (not shown) to modulate location tracking information and provide the modulated information to the antenna(s) module 430 for transmission of signals. In some embodiments, the narrowband transceiver module includes a ZigBee radio.

FIG. 4 shows broadcast and reception of signals between the tag unit 115-b and several APs 105. In the system 400, several APs 105-c through 105-n are shown communicating with the tag unit 115-b; those skilled in the art will recognize that the tag unit 115-b may communicate with any number of APs 105. By way of illustration, the tag unit 115-b may transmit a UWB pulse, utilizing the UWB transmitter module 450, to several APs 105. The UWB transmitter module 450 may include a transmit filter configured such that the transmitted pulse is sent with maximum power, as allowed by governing regulations. The transmit filter configuration may include certain coefficients that are a function of the chip rate of the transmitted pulse. In some cases, the pulse may be an analog sequence.

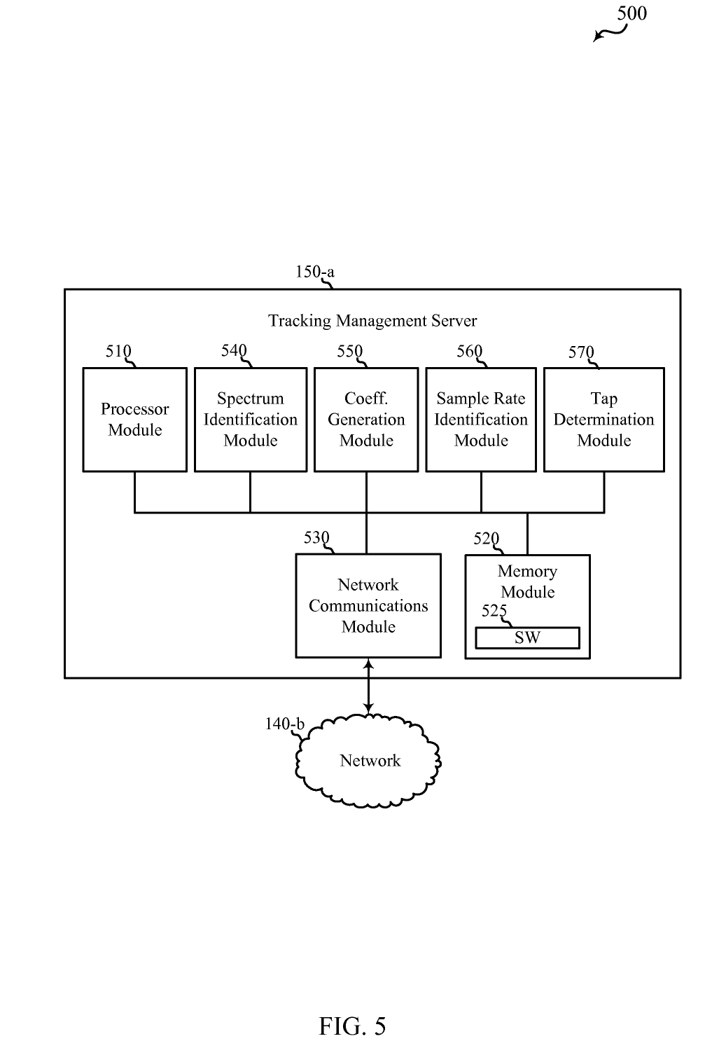

Now turning to FIG. 5, which shows a block diagram of a system 500 configured for communication within a location tracking system according to various embodiments. In some embodiments, the system 500 includes a tracking management server 150-a, which may be the tracking management server 150 of FIGS. 1A and 1B. The tracking management server 150-a may include a processor module 510, a memory module 520 (and software 525), a network communications module 530, a spectrum identification module 540, a coefficient generation module 550, a sample rate identification module 560, and/or a tap determination module 570.

According to some embodiments, the tracking management server 150-a may perform some or all of the functions described with reference to the controller module 215-a of FIG. 2B. For example, the tracking management server 150-a may determine a pulse shaping filter in order to maximize transmit power of an UWB pulse and it may cause APs 105 and/or tags 115 to employ the determined pulse shaping filter. The spectrum identification module 540 may identify a spectral mask and/or a spectral efficiency. The coefficient generation module 550 may generate transmit filter coefficients at a fraction (e.g., one-half) of a carrier frequency, based on the identified spectral mask and/or efficiency. Those skilled in the art will recognize that generating coefficients at a fraction of the carrier frequency (e.g., radio frequency) may help reduce power consumption of devices employing the coefficients by, for example, relaxing transition speeds of analog circuits associate with the device. In some embodiments, the coefficient generation module 550 may also identify a maximum transmit filter coefficient. The sample rate identification module 560 may identify a sampling rate of a UWB pulse based on a carrier frequency. In some cases, the tap determination module 570 determines a number of transmit filter taps based on the maximum transmit filter and the sampling rate. The various modules of the tracking management server 150-a may transmit information related to pulse shaping to the APs 105 and/or tags 115 via the network communications module 530 and the network 140-b.

The processor module 510 may also perform various operations related to pulse shaping; and, in some embodiments, it includes an intelligent hardware device (e.g., a CPU). The tracking management server 150-a may also communicate with a network 140-b through the network communications module 530 to send information to and/or receive information from APs 105 regarding generating and/or identifying transmit filter characteristics. Likewise, the tracking management server 150-a may send or receive information related to identified or identifying channel characteristics. The network 140-b may be an example of the networks 140 of any or all of FIGS. 1A, 1B, and 3.

The memory module 520 may include RAM or ROM, or both. In some embodiments, the memory module 520 stores computer-readable, computer-executable software code 525 containing instructions that are configured to, when executed, cause the processor module 510 to perform various functions described herein. In other embodiments, the software code 525 may not be directly executable by the processor module 510; but the software code 525 may be configured to cause a computer, e.g., when compiled and executed, to perform the functions described herein.

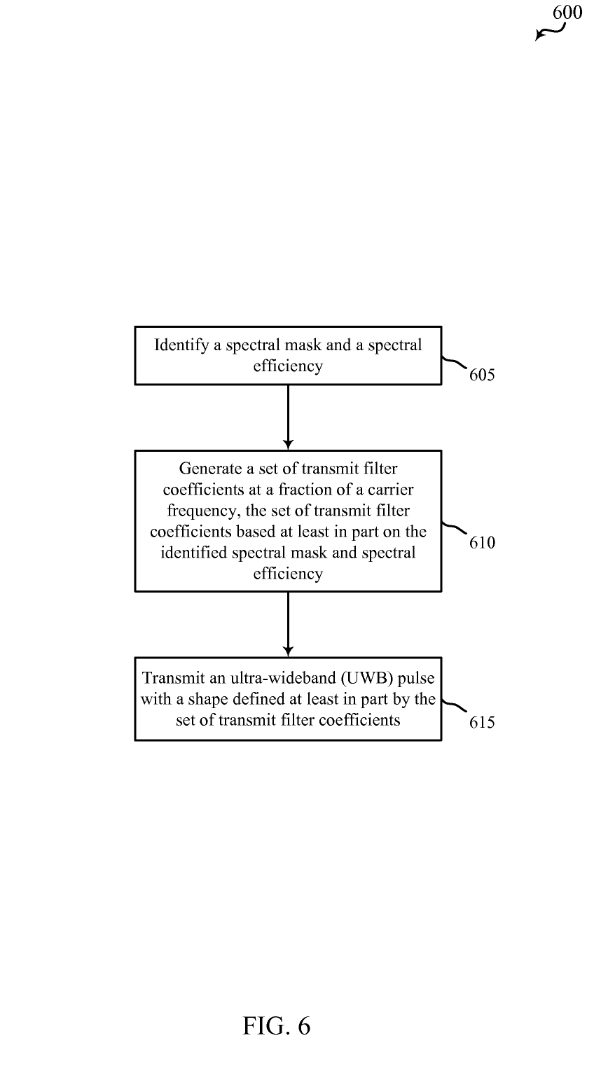

FIG. 6 is a flow diagram illustrating one embodiment of a method 600 to maximize a transmit power of an ultra-wideband (UWB) pulse. In one configuration, the method 600 may be implemented by an access point 105 and/or a tag 115 of FIGS. 1A, 1B, 2A, 2B, 2C, 3, and/or 4. The method 600 may also be implemented by the tracking management server 150 of FIGS. 1A, 1B, and/or 5. In particular, the method 600 may be implemented by the controller module 215 of FIGS. 2A, 2B, 3, 4, and/or 5.

In one configuration, at block 605, a spectral mask and a spectral efficiency may be identified. At block 610, a set of transmit filter coefficients may be generated. In one example, the transmit filter coefficients may be generated at a fraction of a carrier frequency. For example, the transmit filter coefficients may be generated at one-half the carrier frequency. In one configuration, the set of transmit filter coefficients may be based at least in part on the identified spectral mask and spectral efficiency. At block 615, an ultra-wideband (UWB) pulse may be transmitted. The UWB pulse may be transmitted with a shape that is defined at least in part by the set of generated transmit filter coefficients.

Thus, the method 600 provides for maximizing the transmit power of the UWB pulse. It should be noted that the method 600 is just one implementation and that the operations of the method 600 may be rearranged or otherwise modified such that other implementations are possible.

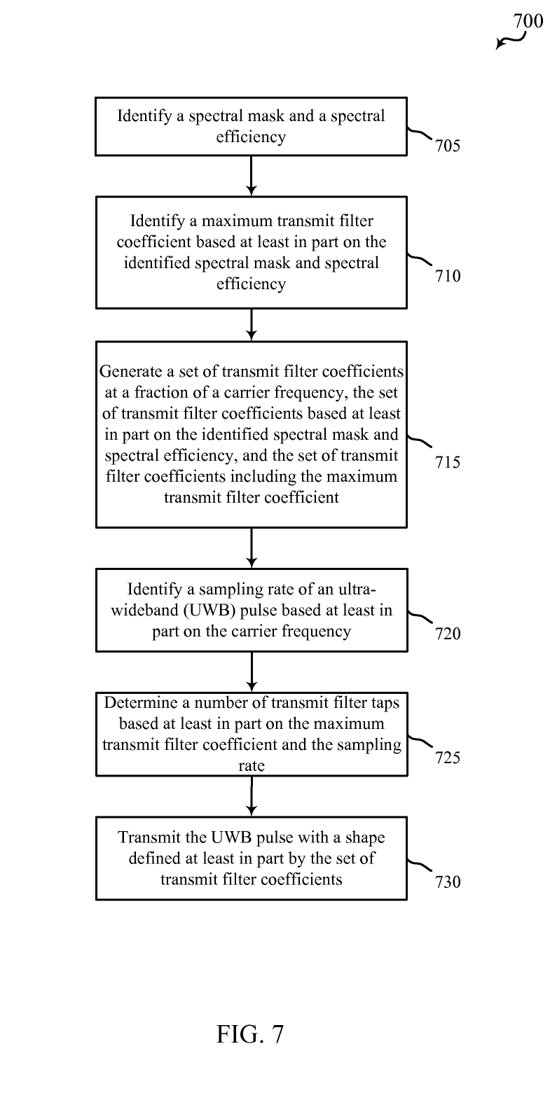

FIG. 7 is a flow diagram illustrating one embodiment of a method 700 to maximize a transmit power of an ultra-wideband (UWB) pulse. In one configuration, the method 700 may be implemented by an access point 105 and/or a tag 115 of FIGS. 1A, 1B, 2A, 2B, 2C, 3, and/or 4. The method 700 may also be implemented by the tracking management server 150 of FIGS. 1A, 1B, and/or 5. In particular, the method 700 may be implemented by the controller module 215 of FIGS. 2A, 2B, 3, 4, and/or 5.

In one configuration, at block 705, a spectral mask and a spectral efficiency may be identified. At block 710, a maximum transmit filter coefficient may be identified. The identification of the maximum transmit filter coefficient may be based at least in part on the identified spectral mask and spectral efficiency.

At block 715, a set of transmit filter coefficients may be generated. In one example, the transmit filter coefficients may be generated at a fraction of a carrier frequency. For example, the transmit filter coefficients may be generated at one-half the carrier frequency. In one configuration, the set of transmit filter coefficients may be based at least in part on the identified spectral mask and spectral efficiency. In one example, the set of transmit filter coefficients may include the identified maximum transmit filter coefficient.

At block 720, a sampling rate of an ultra-wideband (UWB) pulse may be identified. The sampling rate may be based at least in part on the carrier frequency. At block 725, a number of transmit filter taps may be determined. The determined number of transmit filter taps may be based at least in part on the maximum transmit filter coefficient and the sampling rate. At block 730, the UWB pulse may be transmitted. The UWB pulse may be transmitted with a shape that is defined at least in part by the set of generated transmit filter coefficients.

Thus the method 700 provides for maximizing the transmit power of the UWB pulse. It should be noted that the method 700 is just one implementation and that the operations of the method 700 may be rearranged or otherwise modified such that other implementations are possible.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not to be limited to the examples and designs described herein, but is to be accorded the widest scope consistent with the principles and novel features disclosed herein.

What is claimed is:

1. A method of maximizing transmit power of an ultra-wideband (UWB) pulse, comprising:
identifying a spectral mask and a spectral efficiency;
generating a set of transmit filter coefficients at a fraction of a carrier frequency, the set of transmit filter coefficients based at least in part on the identified spectral mask and spectral efficiency; and
transmitting the UWB pulse with a shape defined at least in part by the set of transmit filter coefficients.

2. The method of claim 1, further comprising:
identifying a maximum transmit filter coefficient based at least in part on the identified spectral mask and spectral efficiency, the set of transmit filter coefficients comprising the maximum transmit filter coefficient.

3. The method of claim 2, further comprising:
identifying a sampling rate of the UWB pulse based at least in part on the carrier frequency.

4. The method of claim 3, further comprising:
determining a number of transmit filter taps based at least in part on the maximum transmit filter coefficient and the sampling rate.

5. The method of claim 1, wherein the fraction of the carrier frequency comprises one-half of the carrier frequency.

6. The method of claim 1, wherein the set of transmit filter coefficients comprise unquantized filter coefficients.

7. The method of claim 1, wherein the set of transmit filter coefficients comprise uniformly quantized filter coefficients.

8. The method of claim 1, wherein the set of transmit filter coefficients comprise non-uniformly quantized filter coefficients.

9. The method of claim 1, further comprising:
implementing the set of transmit filter coefficients in passband by modulating a radio frequency (RF) carrier at the carrier frequency.

10. The method of claim 1, further comprising:
modulating a radio frequency (RF) carrier with each gain provided by the set of transmit filter coefficients, the RF carrier being modulated with each gain for a period of two RF cycles.

11. The method of claim 1, wherein the spectral mask comprises a universal spectral mask.

12. An apparatus for maximizing transmit power of an ultra-wideband (UWB) pulse, comprising:
means for identifying a spectral mask and a spectral efficiency;
means for generating a set of transmit filter coefficients at a fraction of a carrier frequency, the set of transmit filter coefficients based at least in part on the identified spectral mask and spectral efficiency; and
means for transmitting the UWB pulse with a shape defined at least in part by the set of transmit filter coefficients.

13. The apparatus of claim 12, further comprising:
means for identifying a maximum transmit filter coefficient based at least in part on the identified spectral mask and spectral efficiency, the set of transmit filter coefficients comprising the maximum transmit filter coefficient.

14. The apparatus of claim 13, further comprising:
means for identifying a sampling rate of the UWB pulse based at least in part on the carrier frequency.

15. The apparatus of claim 14, further comprising:
means for determining a number of transmit filter taps based at least in part on the maximum transmit filter coefficient and the sampling rate.

16. The apparatus of claim 12, wherein the fraction of the carrier frequency comprises one-half of the carrier frequency.

17. The apparatus of claim 12, further comprising:
means for implementing the set of transmit filter coefficients in passband by modulating a radio frequency (RF) carrier at the carrier frequency.

18. The apparatus of claim 12, further comprising:
means for modulating a radio frequency (RF) carrier with each gain provided by the set of transmit filter coefficients, the RF carrier being modulated with each gain for a period of two RF cycles.

19. An apparatus for maximizing transmit power of an ultra-wideband (UWB) pulse, comprising:
a processor;
a memory in electronic communication with the processor; and
instructions being stored in the memory, the instructions being executable by the processor to:
identify a spectral mask and a spectral efficiency;
generate a set of transmit filter coefficients at a fraction of a carrier frequency, the set of transmit filter coefficients based at least in part on the identified spectral mask and spectral efficiency; and
transmit the UWB pulse with a shape defined at least in part by the set of transmit filter coefficients.

20. The apparatus of claim 19, wherein the instructions are executable by the processor to:
identify a maximum transmit filter coefficient based at least in part on the identified spectral mask and spectral efficiency, the set of transmit filter coefficients comprising the maximum transmit filter coefficient.

21. The apparatus of claim 20, wherein the instructions are executable by the processor to:
identify a sampling rate of the UWB pulse based at least in part on the carrier frequency.

22. The apparatus of claim 21, wherein the instructions are executable by the processor to:
determine a number of transmit filter taps based at least in part on the maximum transmit filter coefficient and the sampling rate.

23. The apparatus of claim 19, wherein the instructions are executable by the processor to:
implement the set of transmit filter coefficients in passband by modulating a radio frequency (RF) carrier at the carrier frequency.

24. The apparatus of claim 19, wherein the instructions are executable by the processor to:
modulate a radio frequency (RF) carrier with each gain provided by the set of transmit filter coefficients, the RF carrier being modulated with each gain for a period of two RF cycles.

25. A computer program product for maximizing transmit power of an ultra-wideband (UWB) pulse, the computer program product comprising a non-transitory computer readable medium, the computer readable medium storing instructions thereon, the instructions being executable by a processor to:
identify a spectral mask and a spectral efficiency;
generate a set of transmit filter coefficients at a fraction of a carrier frequency, the set of transmit filter coefficients based at least in part on the identified spectral mask and spectral efficiency; and
transmit the UWB pulse with a shape defined at least in part by the set of transmit filter coefficients.

26. The computer program product of claim 25, wherein the instructions are executable by the processor to:
identify a maximum transmit filter coefficient based at least in part on the identified spectral mask and spectral efficiency, the set of transmit filter coefficients comprising the maximum transmit filter coefficient.

27. The computer program product of claim 26, wherein the instructions are executable by the processor to:
identify a sampling rate of the UWB pulse based at least in part on the carrier frequency.

28. The computer program product of claim 27, wherein the instructions are executable by the processor to:
determine a number of transmit filter taps based at least in part on the maximum transmit filter coefficient and the sampling rate.

29. The computer program product of claim 25, wherein the instructions are executable by the processor to:
implement the set of transmit filter coefficients in passband by modulating a radio frequency (RF) carrier at the carrier frequency.

30. The computer program product of claim 25, wherein the instructions are executable by the processor to:
modulate a radio frequency (RF) carrier with each gain provided by the set of transmit filter coefficients, the RF carrier being modulated with each gain for a period of two RF cycles.
